(19) United States
(12) Patent Application Publication
(10) Pub. No.: US 2010/0084451 A1
(43) Pub. Date: Apr. 8, 2010

(54) Tapered guide bushing for reciprocating driver and tool incorporating same

(76) Inventor: Keith Daniel Abla, Kalamazoo, MI (US)

Correspondence Address: Keith Daniel Abla, 9980 West D.E. Ave., Kalamazoo, MI, 49009, US

(21) Appl. No.: 12/460,287

(22) Filed: Jul. 16, 2009

Related U.S. Application Data
(60) Provisional application No. 61/081,062, filed on Jul. 16, 2008.

(51) Int. Cl. B25C 1/04

(52) U.S. Cl. 227/107

(57) ABSTRACT

A guide bushing for a reciprocating nailer includes a body having a cylindrical portion and a tapered portion. An aperture extends through the body for receiving a driving rod. The tapered portion of the guide bushing extends from the nailer and is configured to fit into tight spaces, such as corners and along the tongues or grooves of, for instance, tongue and groove flooring, to fully support a nailer as it is driven into the tight space. The guide bushing can be a multiple part or multiple stage bushing for more flexibility and utility. The aperture through the center of the bushing can also be stepped to cooperate with a stepped driving rod for closer holding of narrower nails. A boot can be placed at the tip of the guide bushing to provide a cushion and further retention of a nail held by the nailer.

### CROSS-REFERENCE TO RELATED APPLICATIONS

This application claims the benefit of provisional patent application Ser. No. 61/081,062, filed Jul. 16, 2008 by the present inventor.

### BACKGROUND

1. Field

This application relates to a compact, reciprocating, electrically or pneumatically operated impact tool, and specifically to an improved nail guide bushing mechanism for palm nailers.

2. Prior Art

The previously known mechanisms for power driving have been of substantial size and weight and dimensionally unsuited for operation in confined areas. Such mechanisms also have primarily incorporated the principle of a single stroke operation, controllable at the desire or will of an operator, and have not normally been adapted for use where relatively short repetitive strokes of a tool or operating mechanism are desirable.

Compact reciprocating impact tools, which are electrically or pneumatically operated (Hammerhead auto hammer, palm nailer) have overcome the drawbacks in these previously mentioned mechanisms, and provide a device of relatively small dimension. Such tools are lightweight, comfortably usable in confined areas by an operator, and substantially reduce problems of manipulation and fatigue by the user.

These compact impact tools can be used in compact areas, but have neglected to address the issue of placing nails which require the impact to be located in compact places, such as the positioning of a nail within a recess that is not accessible by the prior art devices. In FIG. 12 the prior art guide bushing or rod has maintained a large face compared to the size of the nail head which it guides. Therefore, if a nail must be located in a narrow channel or in the inside corner of a tongue and groove floor, the impact tool cannot nail in confined nail placement areas.

Prior-Art people failed to address this problem because a mini palm nailer for example is designed for a broad use, up to 16d nails. Therefore the guide bushing must have a bore in the end large enough to receive the head of a 16d nail plus the perimeter of the bushing including the thickness plus room for a magnetic holder leaving a large diameter at the end of the guide bushing. Prior-art has designed the nailers for nail placement on flat surfaces which is generally found.

### SUMMARY

A rod with a conical or taper which can be round, flat, or tapered at the nose of a guide bushing. The guide bushing is modified for a variety of fasteners. A second guide bushing can be used for additional support. The guide bushing has a peripheral collar is slide mounted in the guide securing collar and thereon adapted for engagement with a circular abutment formed in the interior bore of the securing collar. A rod driver can be modified for a variety of fasteners.

One embodiment of this tool is FIG. 13 a mini palm nailer with a driver rod slightly larger than a finish nail. The guide bushing is tapered with a bore to both guide the driver rod and the fastener. The taper allows the fastener to be driven in the tongue of a floor board while operating close to a wall.

### DRAWINGS

FIG. 1 is an exploded perspective view of a palm nailer incorporating a tapered guide bushing according to the invention.

FIG. 2 is an enlarged perspective view of the tapered guide bushing of FIG. 1.

FIG. 3 is an enlarged perspective view of a driver of the palm nailer of FIG. 1.

FIG. 4 is an enlarged view of the tip of the tapered guide bushing of FIG. 3 (showing a circumferential groove for receiving a cushioned tip/boot).

FIG. 5 is an exploded perspective view of a palm nailer incorporating a tapered guide bushing and stepped driver according to a further embodiment of the invention.

FIG. 5A is an enlarged exploded perspective view of a tapered guide bushing assembly of FIG. 5

FIG. 6 is an enlarged perspective view of the tapered guide bushing of FIG. 5.

FIG. 7 is an enlarged perspective view of a stepped driver of the palm nailer of FIG. 5.

FIG. 8 is a perspective view of a plurality detention guide bushing assembly.

FIG. 8A is an exploded perspective view of a plurality detention guide bushing assembly with a step driver according to a further embodiment of the invention of FIG. 8.

FIG. 8B is an exploded perspective view of a plurality detention guide bushing assembly with a straight driver according to a further embodiment of the invention.

FIG. 9 is an enlarged perspective view of the tapered guide bushing (with an apse tip) according to a further embodiment of the invention.

FIG. 10 is an enlarged perspective view of a tapered guide bushing (with flat tip) according to a further embodiment of the invention.

FIG. 11 is an enlarged perspective view of a tapered guide bushing (with a wedged tip) according to a further embodiment of the invention.

FIG. 12 is a perspective view of a prior art palm nailer.

FIG. 13 is an enlarged perspective view of a palm nailer with a tapered guide bushing according to a further embodiment of the invention.

FIG. 14 is a perspective view of a prior art palm nailer positioned to drive a nail in a confined space and angled location and is unable to achieve the proper result.

FIG. 15 is a perspective view of a palm nailer according to the invention positioned to drive a nail in a confined space and angled location.

### DETAILED DESCRIPTION

### First Embodiment—FIGS. 5A and 5

FIG. 5A is an enlarged exploded perspective view of a tapered guide bushing assembly of FIG. 5.

FIG. 5A shows a guide bushing 520 has a taper 522 to a sharp edge tip 526. A magnet 528 is adhered in a perpendicular bore 530 to a guide bushing bore 524. The guide bushing 520 has a stepped center bore 536 forming a shoulder 534 which is congruent in shape to a driver rod 570 with a shoulder 544. The driver rod 570 is guided by the guide bushing bore 524. The guide bushing 520 has a stepped bore 538 forming a spring seat 539. The guide bushing has a peripheral collar 532 which is slide mounted into a removable guide sleeve securing collar 560 and thereon adapted for engagement with a circular abutment 562 formed in the interior bore 564 of the securing collar 560. The driver rod 570 is threaded into FIG. 5 a piston 572. FIG. 5 shows the piston 572 attached to the driver rod 570 showing a removable assembly 570 and 572 is encased in both a lower housing 505 and upper housing 508 secured together with alien screws 509. FIG. 5A shows the driver end 574 is inserted through FIG. 5 a body bore 510, a spacing washer 504, the spring 540, the guide sleeve 520, the guide bushing bore 526, and the securing collar bore 560. A prior art guide bushing 502 is shown.

These specifics are what I presently prefer for this embodiment and “I presently contemplate that the guide bushing 520 of the embodiment of FIG. 5A having a circular cross section with a circular bore 524 and be made of 4041 steel. However this embodiment can have different cross sections, such as oval, triangular, rectangular, square, hexagonal, etc. and different shaped guide bushing with varying bores, with drive rods of varying sizes and shape for a variety of fasteners. These can be made of materials such as austenitic steel, high carbon steel, magnetized steel, titanium, polycarbonates, etc.” With the embodiment of 5A and others it will be important to provide a choice of driver rod assemblies an assortment of guide bushing, springs, securing collars and tools to disassemble and assemble.

### Operation

FIG. 5A is an enlarged exploded perspective view of a tapered guide bushing assembly of FIG. 5.

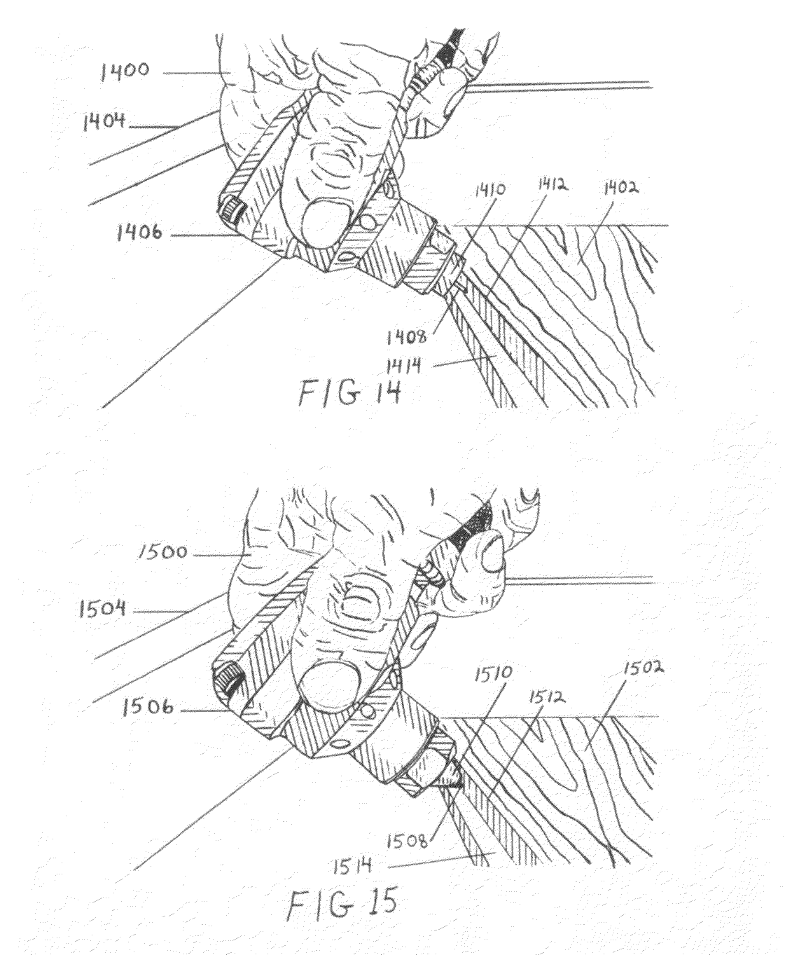

FIG. 5A shows an exploded perspective view of one embodiment of a tapered detention rod guide bushing assembly. A guide bushing 520 is retractable upon contact with the receiving member into which the fastener is being driven. The guide bushing 520 has a taper 522 which intersects a guide bushing bore 524 at a sharp edge tip 526. A magnet 528, which holds a fastener, is adhered in a perpendicular bore 530 to the guide bore 524. The guide bore 524 has a stepped bore 536 which guide a driver rod 570 which also has a stepped shoulder 544 to match the bore shoulder 534. FIG. 5 the lower assembly consisting a removable guide securing collar 560 which joins the guide bushing 520 with a mating guide bushing peripheral collar 532, which is slide mounted into the securing collar 560 and thereon adapted for engagement with a circular abutment 562 formed in a interior bore 564 of the securing collar 560. The securing collar 560 secures the FIG. 5A tapered guide bushing assembly by threading into FIG. 5 the body threads 514. The driver rod 570 is threaded into a piston 572 forming a removable driver rod assembly 570 and 572 which is encased in both a lower housing 505 and upper housing 508 secured together with alien screws 509. A driver end 576 is inserted through body bore 510, a spacing washer 504, the spring 540, the guide bushing bore 524, and the securing collar bore 564. FIG. 5A the top of the guide bushing 520 has a spring seat bore 538, forming a spring seat shoulder 539 on which mounts a spring 540 that inter engage between FIG. 5 a spacing washer 504 abutting a body 512. The spring 540 forces the guide bushing 520 outward, the bushing bore 524 supports fasteners. As the operator applies pressure activating impact the spring 540 allowing the guide bushing 520 to retract as the bushing makes contact with the surface, while guiding and supporting the fastener to the surface. The guide bushing 520 has a peripheral collar 532 is slide mounted in the guide sleeve securing collar 560 and thereon adapted for engagement with a circular abutment 562 formed in the interior bore 564 of the securing collar 560 at the lower end of an enlarged diameter bore 564 and by inter coactions there between serves as a guide for maintaining positive alignment of the driving end 576 with a head of a fastener during impact, while also providing positive limit stops. When pressure is applied between a fastener to be driven and the driver end 576 activating rapid reciprocating impact until the fastener reaches its predetermined depth which deactivates impact. Depth is controlled by additional FIG. 5 spacing washers 504 or fewer spacing washers 504 and the desired depth to set the fastener. This embodiment enabling the operator FIG. 14 to connect a variety of fasteners in confined nail placement areas in addition to normal fastener placement areas.

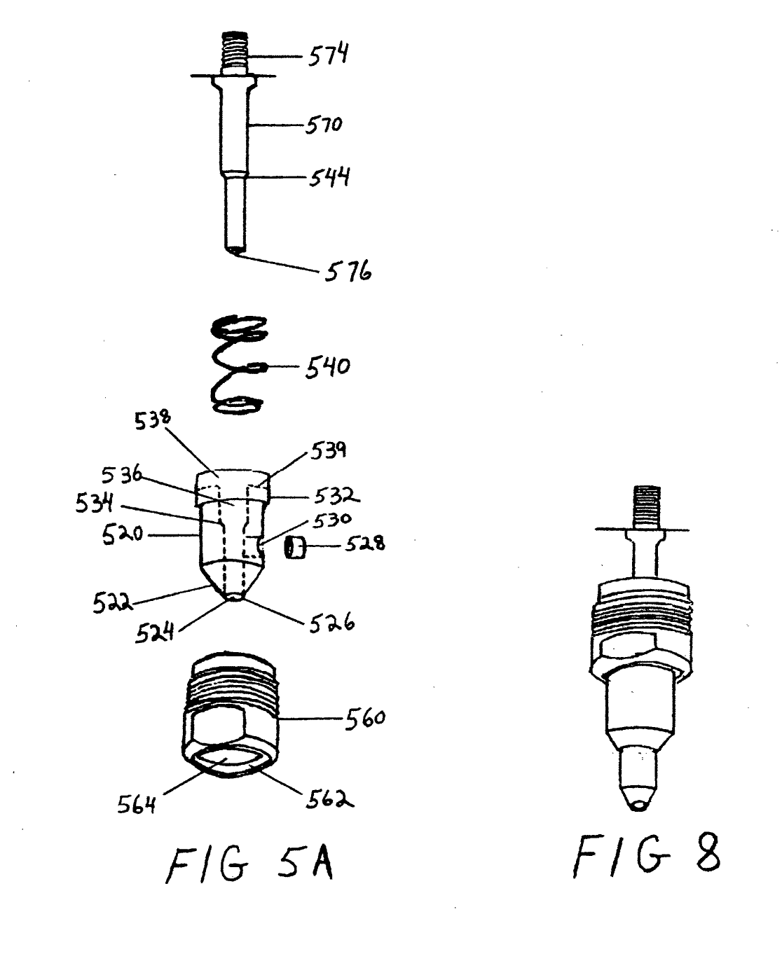

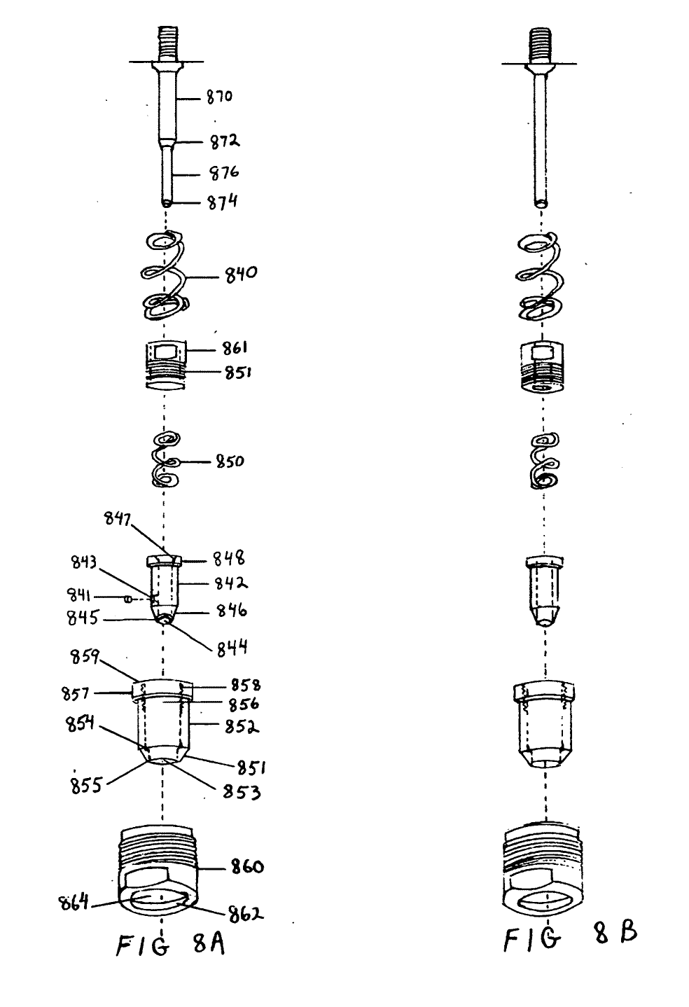

FIG. 8A is an exploded perspective view of a plurality detention guide bushing assembly with a step driver according to a further embodiment of the invention of FIG. 8

FIG. 8A shows a dual detention guide assembly which consist of a detention rod guide bushings 842 and a detention rod guide bushing 852. The guide bushing 842 retracts upon contact with the receiving member into which the fastener is being driven, to facilitate continued driving of the item to its proper depth. The guide bushing 842 with a taper 846 to an apse 845 which intersects a guide bushing bore 844. A magnet 841 is adhered in a perpendicular bore 843 which intersects the guide bore 844. The guide bushing 842 has a peripheral collar 848 and is slide mounted into a larger first guide bushing 852 from the top and thereon adapted for engagement with a circular abutment 854 formed in a bore 856 of the guide bushing 852. A spring 850 is inserted into the bushing bore 856 on top of the guide bushing 842. A threaded bore sleeve 851 is inserted into a threaded bore 858 of guide bushing 852. By inter coactions there between serves as a guide for maintaining positive alignment of a driving end 874 with a head of a fastener during impacting, while also providing positive limit stops. The guide bushing 842 has an interior peripheral collar 847 congruent with a driver rod 870 and a shoulder 872. The guide bushing 852 has a taper 851 which intersects the guide bore 853 at a sharp edged tip 855. The guide bushing 852 has a peripheral collar 857 which is slide mounted in a securing collar 860 and thereon adapted for engagement with a circular abutment 862 formed in a bore 864 of the securing collar 860. By inter coactions there between serves as a guide for maintaining positive alignment of the driving end 874 with a head of a fastener during driving, while also providing positive limit stops. A spring 840 inter engage between FIG. 5 a body 505 and FIG. 8A both a neck 861 and bushing shoulder 859. Both springs 850 and 840 act independently allow both guide bushings 842 and 852 to fully extend allowing the guide bushing 852 to support the guide bushing 842 which supports the fastener. Allowing both the guide bushings 842 and 852 to retract independently as the operator applies pressure while driving fasteners. The driver rod 870 narrows at the shoulder 872 to a smaller rod dimension 876 with the driver end 874. When pressure is applied between a fastener to be driven and the driver end 874 activating rapid reciprocating impact until the fastener reaches its predetermined depth which deactivates impact. Depth is controlled by additional FIG. 5 spacing washers 504 or fewer spacing washers 504 and the desired depth. This embodiment enabling the operator FIG. 14 to connect fasteners in confined nail placement areas in addition to normal fastener placement areas.

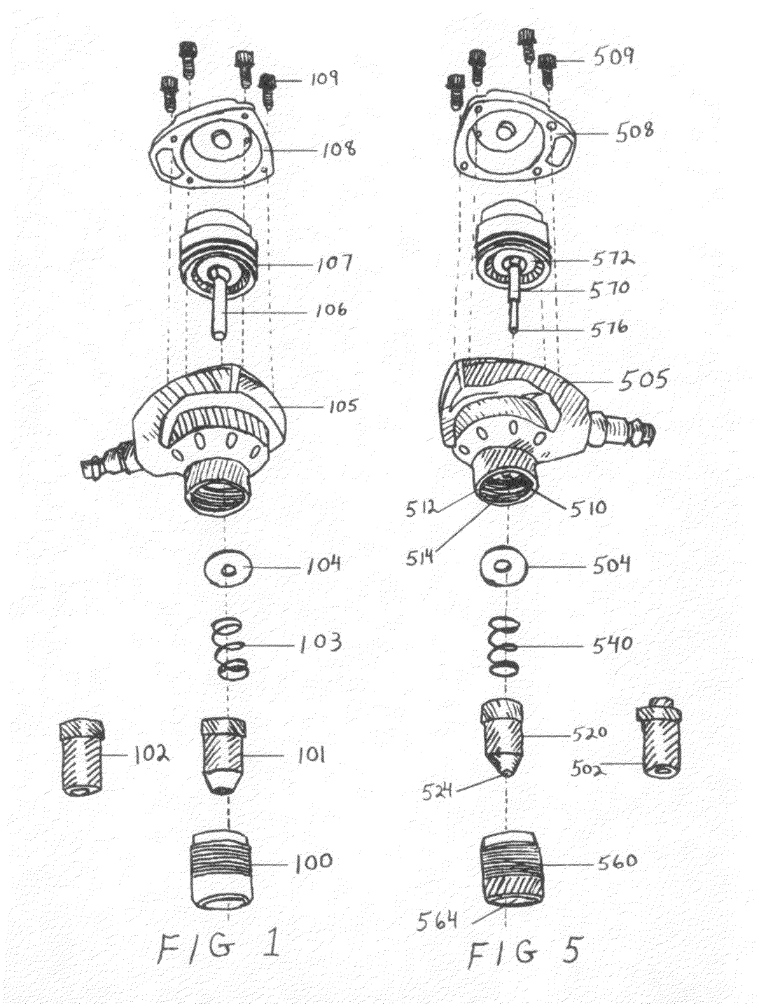

FIG. 1 is an exploded perspective view of a palm nailer incorporating a tapered guide bushing according to the invention.

This embodiment consist of a securing collar 100, a tapered guide bushing 101, prior art straight guide bushing 102, a spring 103, a spacing washer 104, a lower body 105, a driver 106, a piston 107, a upper body 108, and a assembly screw set 109.

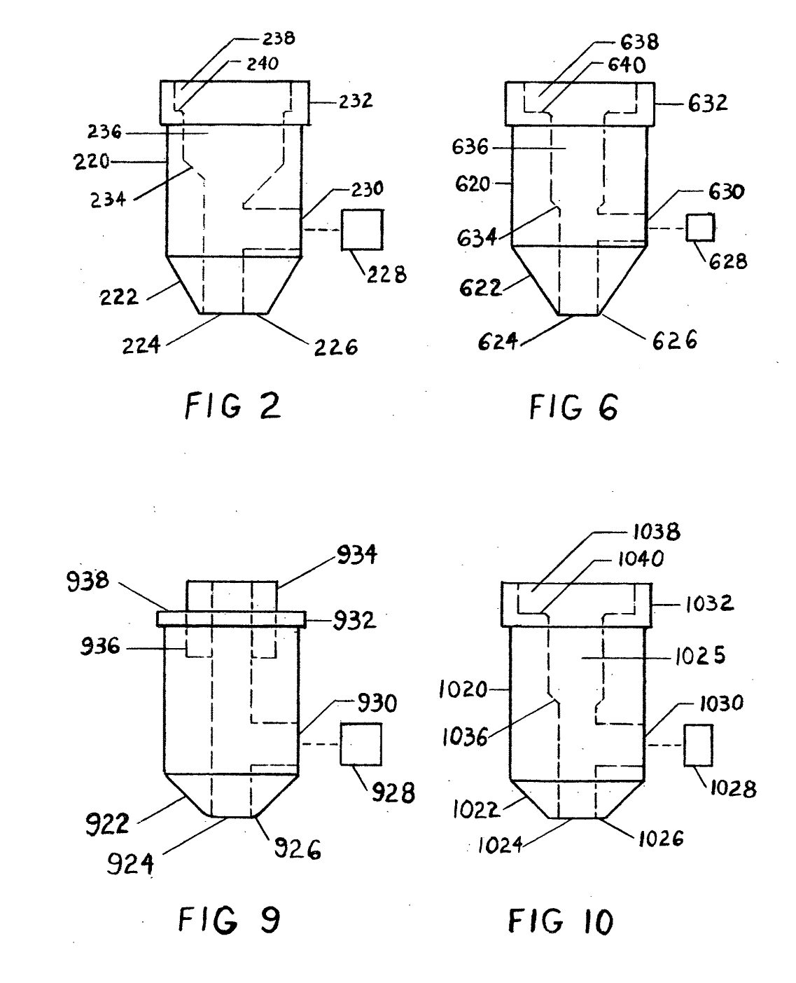

FIG. 2 is an enlarged perspective view of the tapered guide bushing of FIG. 1 according to a further embodiment of the invention.

A guide bushing 220 with a taper 222 to a flat tip 226. A magnet 228 is adhered in a perpendicular bore 230 to a guide bushing which intersects an off centered bushing bore 224. The guide bushing 220 has a stepped centered shoulder bore 236, forming a shoulder 234, and a stepped bore 238 forming a spring seat 240. The guide bushing 220 has an upper peripheral collar 232.

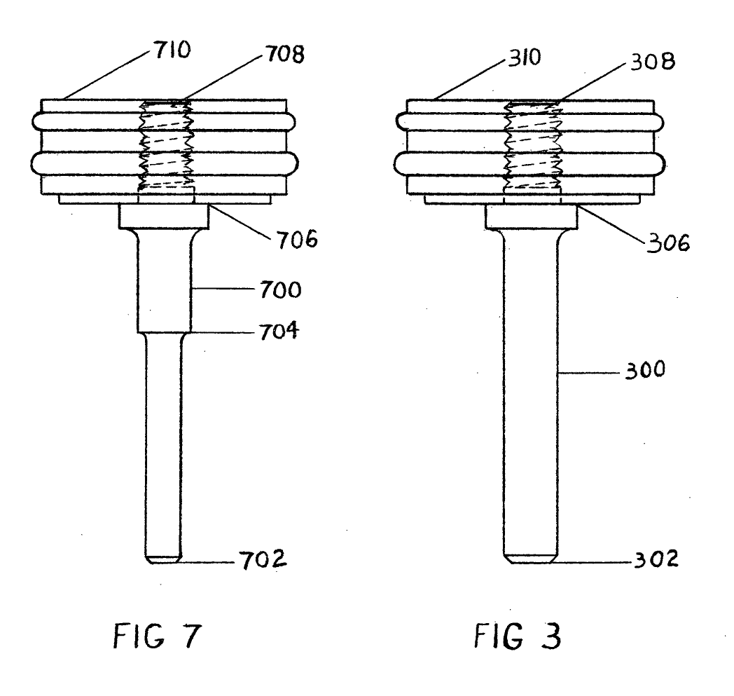

FIG. 3 is an enlarged perspective view of a driver of the palm nailer of FIG. 1.

The driver consists of a straight driver 300, a driver end 302, an upper shoulder 306, and a threaded end 308. The treaded end 308 is connected to a piston 310

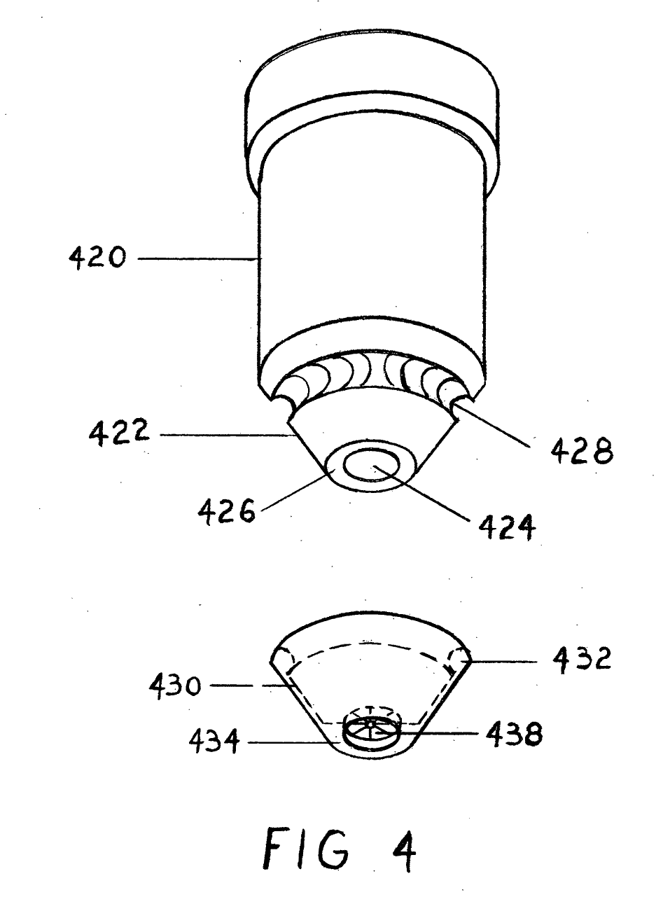

FIG. 4 is an enlarged view of the tip of the tapered guide bushing of FIG. 2 (showing a circumferential groove for receiving a cushioned tip/boot).

FIG. 4 shows a guide bushing 420 with a taper 422 to a flat tip 426 joining a guide bore 424. The taper has an o-ring groove 428 cut in the upper circumference of the taper 422 to hold a protective cushioned boot 430 by an upper o-ring band 432. The boot 430 fits the flat tip 426 with a flat sided o-ring sole 434. The o-ring sole 434 does not protrude the bore 424 giving the tip a non marring surface. On the top side of the o-ring sole 434 is a flexible nail centering retainer 438 allowing enough room for a finish nail to set through the retainer 438.

FIG. 6 is an enlarged perspective view of the tapered guide bushing of FIG. 5 according to a further embodiment of the invention.

FIG. 6 shows a guide bushing 620 with a taper 622 to a sharp edge tip 626. A magnet 628 is adhered in a perpendicular bore 630 which intersects a guide bushing bore 624. The guide bushing 620 has a stepped center bore 636 forming a shoulder 634. The guide bushing 620 has a stepped bore 638 forming a spring seat 640. The guide bushing 620 has an upper peripheral collar 632.

FIG. 7 is an enlarged perspective view of a stepped driver of the palm nailer of FIG. 5.

FIG. 7 shows a stepped driver 700 which consist of a driving end 702, a mid shoulder 704, an upper shoulder 706, and the threaded end 708. The threaded end 708 is connected to a piston 710.

FIG. 9 is an enlarged perspective view of the tapered guide bushing (with an apse tip) according to a further embodiment of the invention.

FIG. 9 shows a guide bushing 920 with a taper 922 to an apse tip 926. A magnet 928 is adhered in a perpendicular bore 930 which intersects a guide bushing straight bore 924. The top of the guide bushing 920 has a guide sleeve 934 inserted into a bore 936 on a flat top spring seat 938. The guide bushing 920 has an upper peripheral collar 932.

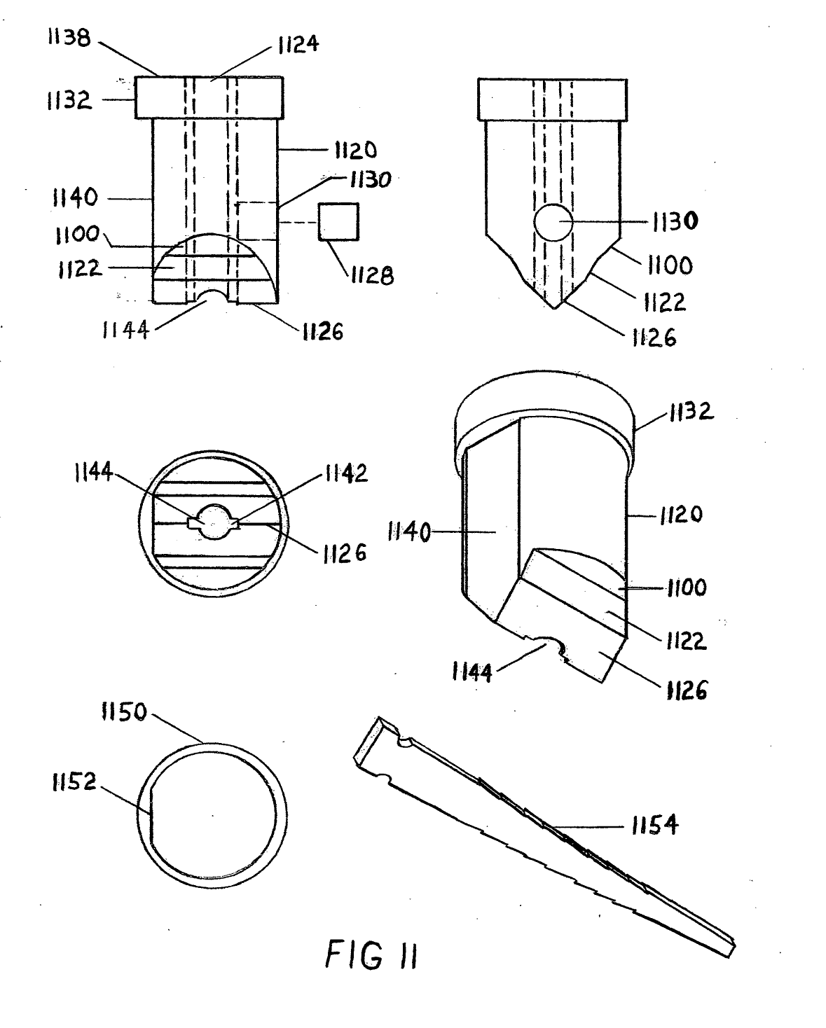

FIG. 10 is an enlarged perspective view of a tapered guide bushing (with flat tip) according to a further embodiment of the invention.

The guide bushing 1020 with a taper 1022 to a flat tip 1026. A magnet 1028 is adhered in a perpendicular bore 1030 to a guide bushing bore 1024. A shoulder bore 1025 forms a shoulder 1036 in the guide bore 1024. The top of the guide bushing 1020 has a stepped bore 1038 forming a spring seat 1040. The upper edge of bushing 1020 has a peripheral collar 1032.

FIG. 11 is an enlarged perspective view of a tapered guide bushing (with a wedged tip) according to a further embodiment of the invention.

FIG. 11 shows a tapered guide bushing 1120 with a main taper 1122 on two sides leaving a shoulder 1100 on each side of the circumference. The taper 1122 joins a beveled tip 1126. The tapered guide bushing 1120 has a flat directional guide 1140 on the outside diameter of the cylinder wall, which matches a directional guide washer 1150 with a congruent flat 1152. A magnet 1128 is adhered in a perpendicular bore 1130 which intersects a guide bushing straight bore 1124. The guide bushing bore 1124 has a broached bore 1142 leaving a Saturn shaped guide bore 1144. The upper edge has a peripheral collar 1132. The top of the guide bushing 1120 has a flat spring seat 1138. This embodiment is used for driving rectangular floor cleats 1154.

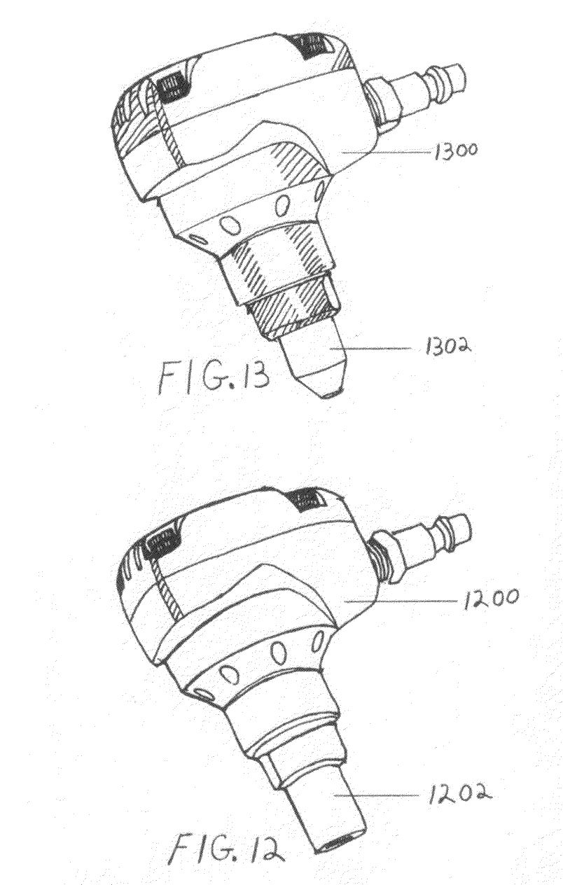

FIG. 12 is a perspective view of a prior art palm nailer.

FIG. 12 shows a prior art palm nailer 1200 with a standard guide bushing 1202.

FIG. 13 is an enlarged perspective view of a palm nailer with a tapered guide bushing according to a further embodiment of the invention.

FIG. 13 shows a palm nailer 1300 with a tapered guide bushing 1302 which is able to position into compact areas for nail placement.

FIG. 14 is a perspective view of a prior art palm nailer positioned to drive a nail in a confined space or angled location and is unable to achieve the proper result.

FIG. 14 shows an operator 1400 installing a tongue and groove pre-finished hardwood floor 1402 in a confined space near a wall 1404, with a prior art mini palm nailer 1406. Most mini palm nailers 1406 are unable to drive a finish nail 1408 successfully. A bent nail can damage the floor finish. Mini palm nailers 1406 are set up for common nails up to 16d nails. If the mini palm nailer 1406 is able to drive the finish nail 1408 the driver is unable to drive much further than a large flat tip guide bushing 1410. The guide bushing 1410 which is resting on a finished floor edge 1412 and on a floor tongue 1414 will not allow the nail 1408 to be set properly. If the nail bending does not damage the floor 1402, the guide bushing 1410 will damage finished floor edge 1412.

FIG. 15 is a perspective view of a palm nailer according to the invention positioned to drive a nail in a confined space or angled location.

FIG. 15 shows an operator 1500 installing a tongue and groove pre-finished hardwood floor 1502 in a confined space near a wall 1504 with a mini palm nailer 1506 according to this embodiment. This embodiment of the palm nailer 1506 is able to drive the finish nail 1508 successfully. The Palm nailer is designed with a guide bushing 1510 that supports the finish nail 1508 and sets the nail 1508 properly. The palm nailer 1506 is able to rest on top of the tongue 1514 and beneath the floor edge 1512 and move freely to adjust the nailing angle without damaging the floor edge 1512. This embodiment will save many hours on hard wood flooring installations and other types of work.

I claim:

1. A guide bushing for a reciprocating nailer, comprising:
a body having a proximal end and a distal end, and defining an aperture extending through the body from the proximal end to the distal end;
a proximal portion of the body defining a shoulder extending distally from the proximal end and having a first diameter;
a generally cylindrical central portion of the body having a second diameter smaller than the first diameter; and
a distal portion of the body tapering from the central portion of the body to a minimum diameter adjacent the aperture at the distal end of the body.

2. The guide bushing according to claim 1, further comprising the aperture extending from the proximal end having a first cross-sectional diameter and including a circular abutment narrowing the aperture to a second cross-sectional diameter that extends to the distal end of the body.

3. The guide bushing according to claim 1, wherein the aperture is non-circular for orienting a flat nail for placement, and an external face of the body includes a flat directional guide oriented relative to the non-circular aperture.

4. The nailing device according to claim 1, further comprising an annular external groove proximally positioned relative to the distal end, and a boot received in the groove and extending distally beyond the distal end of the cylindrical body.

5. The nailing device according to claim 4, further comprising the boot having a proximal end and a distal end, the proximal end including a proximal o-ring for receipt in the annular groove and the distal end including a distal o-ring and a nail-centering retainer.

6. A nailing device, comprising:
a housing defining an internal cavity;
a driver arranged for reciprocal movement within the internal cavity and having a rod portion arranged in a driving direction;
a guide bushing assembly extending from the housing in the driving direction, the guide bushing assembly including a guide bushing and a securing collar, wherein the guide bushing comprises a body having a proximal end and a distal end, and defining an aperture extending through the body from the proximal end to the distal end, a proximal portion of the body defining a shoulder extending distally from the proximal end and having a first diameter, a generally cylindrical central portion of the body having a second diameter smaller than the first diameter, and a distal portion of the body tapered from the central portion of the body to a minimum diameter adjacent the aperture at the distal end of the body.

7. The nailing device according to claim 6, wherein the guide bushing assembly is removably attached to the housing.

8. The nailing device according to claim 6, further comprising the aperture extending from the proximal end having a first cross-sectional diameter and including a circular abutment narrowing the aperture to a second cross-sectional diameter that extends to the distal end of the cylindrical body.

9. The nailing device according to claim 8, further comprising the rod portion of the driver having a proximal portion and a distal portion, the proximal portion having a first diameter and a including a shoulder portion narrowing the rod to a second diameter that extends to the distal end.

10. The nailing device according to claim 6, wherein the aperture is non-circular for orienting a flat nail for placement, and an external face of the body includes a flat directional guide for orienting the non-circular aperture within the body in cooperation with a directional guide washer in the securing collar.

11. The nailing device according to claim 6, wherein the guide bushing comprises a first guide bushing, and the nailing device further comprises a second guide bushing having a proximal end and a distal end, a proximal portion defining a shoulder and a generally cylindrical central portion, and a distal portion tapering to the distal end of the second guide bushing, the second guide bushing being received within the aperture of the first guide bushing, the shoulder portion of the second guide bushing engaging the circular abutment within the aperture of the first guide bushing.

12. The nailing device according to claim 6, wherein the guide bushing further comprises an annular external groove proximally positioned relative to the distal end.

13. The nailing device according to claim 12, further comprising a boot received in the annular external groove and extending distally beyond the distal end of the cylindrical body.

14. The nailing device according to claim 13, further comprising the boot having a proximal end and a distal end, the proximal end including a proximal o-ring for receipt in the annular groove.

15. The nailing device according to claim 14, wherein the boot further comprises the distal end including a distal cushion and a nail-centering retainer.

16. The nailing device according to claim 6, wherein the guide bushing further comprises a transverse aperture for receiving a magnet.

17. The nailing device according to claim 6, wherein said driver comprises a first driver, and the nailing device further comprises a second driver, the first and second drivers being selectively interchangeable within the internal cavity.

18. The nailing device according to claim 17, wherein the guide bushing assembly comprises a first guide bushing assembly, and the nailing device further comprises a second guide bushing assembly, the first and second guide bushing assemblies being selectively interchangeable in the nailing device.

19. The nailing device according to claim 6, wherein the guide bushing assembly comprises a first guide bushing assembly, and the nailing device further comprises a second guide bushing assembly, the first and second guide bushing assemblies being selectively interchangeable in the nailing device.

20. A nailing device assembly, comprising a housing defining an internal cavity, a plurality of drivers and a plurality of guide bushing assemblies, wherein one of the plurality of drivers is selectively arranged for reciprocal movement within the internal cavity and one of the plurality of guide bushing assemblies is selectively attached to the housing and extending from the housing, said one of said guide bushing assemblies including at least one guide bushing and a securing collar, wherein the guide bushing comprises a body having a proximal end and a distal end, and defining an aperture extending through the body from the proximal end to the distal end, a proximal portion of the body defusing a cylindrical portion and a distal portion of the body tapered from the central portion of the body to a minimum diameter adjacent the aperture at the distal end of the body.
